(19) United States
(12) Patent Application Publication
(10) Pub. No.: US 2024/0029525 A1
(43) Pub. Date: Jan. 25, 2024

(54) SYSTEMS AND METHODS FOR TESTING POINT-OF-SALE DEVICES

(71) Applicant: AHOLD DELHAIZE LICENSING SÀRL, Geneva (CH)

(72) Inventors: Deep Saran MASANAM, Mooresville, NC (US); Karl GICZKOWSKI, Quincy, MA (US); Raphael OBU, Mooresville, NC (US); John NEWTON, Boston, MA (US)

(21) Appl. No.: 18/356,846

(22) Filed: Jul. 21, 2023

Related U.S. Application Data
(60) Provisional application No. 63/369,126, filed on Jul. 22, 2022.

(51) Int. Cl. G07G 1/12; G07G 1/00

(52) U.S. Cl. CPC G07G 1/12; G07G 1/0018

(57) ABSTRACT

In an exemplary embodiment, a system for testing a point-of-sale (POS) device including a card stack mechanism having a plurality of card stacks configured to hold a plurality of cards, a card insert-pay mechanism configured to insert one of the plurality of cards into the POS device to be tested, a card swipe mechanism configured to swipe one of the plurality of cards into the POS device to be tested, and a card screen pin-pad mechanism configured to select a key on a keypad or an operation displayed on a display of the POS device associated with one of the card insert-pay mechanism or the card swipe mechanism.

### CROSS REFERENCE TO RELATED APPLICATION

The application claims priority to U.S. provisional application 63/369,126, filed Jul. 22, 2022, entitled “Systems and Methods for Testing Point-of-Sale Devices”, of which is hereby incorporated by reference in its entirety.

### TECHNICAL FIELD

The present disclosure relates to a point-of-sale (POS) system. More specifically, the present disclosure is directed to systems and methods for testing a POS automation device.

### BACKGROUND

Today, as more purchases made in businesses are made through electronic transactions, electronic devices, such as point-of-sale (POS) system are used to complete the transactions. These systems are complex systems that can include multiple hardware peripherals and software applications. For example, a POS terminal may include a computing device with a display device, a card reader employing an insert-pay mechanism and/or a slide mechanism, a pin-pad mechanism, as well as a handheld scanner, a printer, and other various supporting systems. Because these hardware systems and software applications involve different types of transactions and require different system protocols, testing should be performed to ensure proper operations. Otherwise, operation errors will occur causing delays at a merchant end. Therefore, prior to operation, a POS testing automation system tests the POS device of the individual features of the systems for compatibility and proper functionalities.

While typically there have been testing procedures set for these POS systems, however, in prior solutions, only a few POS system features were implemented and incorporated into a testing suite. That is, these POS testing automation systems only tested the electronic cards for a single testing suite at a time, i.e., testing via an insert-pay mechanism or a slide mechanism, but not both. Moreover, these prior testing procedures have limited testing capabilities and unable to test for full functionalities, such as, unable to access a secure network, difficulty in formulating a test plan, and/or failing to address a fall-back scenario (i.e., fall-back scenario occurs when a EMV chip card is inserted and fails to read three consecutive times due to a chip error, then the EMV chip card is swiped).

In view of the problems associated with the prior devices, there remains a need to provide a device that is capable of testing individual features of POS systems, and addressing all of the problems discussed above.

### SUMMARY

In an exemplary embodiment, a system for testing a point-of-sale (POS) device including a card stack mechanism having a plurality of card stacks configured to hold a plurality of cards, a card insert-pay mechanism configured to insert one of the plurality of cards into the POS device to be tested, a card swipe-pay mechanism configured to swipe one of the plurality of cards into the POS device to be tested, and a card screen pin-pad mechanism configured to select a key on a keypad or an operation displayed on a display of the POS device associated with one of the card insert-pay mechanism or the card swipe-pay mechanism.

In another exemplary embodiment, a system for testing a point-of-sale (POS) device including a plurality of card stacks configured to hold a plurality of cards, a first arm configured to retrieve a card from the plurality of card stacks, a second arm, cooperatively interfacing with the first arm, configured to carry the retrieved card to the POS device, a third arm, cooperatively interfacing with the first arm, configured to carry the retrieved card to the POS device, an input device configured to interface with a screen and a pin-pad of the POS device to select an operation of transaction, and a controller communicatively coupled to each of the first arm, the second arm, the third arm, and the input device. The controller is configured to insert, via the second arm, the retrieve card into the POS device for testing, swipe, via the third arm, the retrieve card into the POS device for testing, and select, via the input device, a press button or a touch screen on the POS device to perform the operation of transaction.

In another exemplary embodiment, a method of testing a point-of-sale (POS) device comprising selecting a card from a plurality of cards, the card including a first transaction type and a second transaction type, determining a transaction mode for the selected card, wherein the transaction mode is one of a card insert-pay mechanism or a card swipe-pay mechanism, determining a failure of either the card insert-pay mechanism or the card swipe-pay mechanism, switching to the card swipe mechanism or the card swipe-pay mechanism that is operational when the failure occur, and selecting an operation on the POS device to complete a transaction.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a schematic view of a point-of-sale (POS) automation system, according to an example embodiment of the present disclosure.

FIG. 2A is a schematic side view of a card stacking system, according to an example embodiment of the present disclosure.

FIG. 2B is a schematic top view of a card stacking system, according to an example embodiment of the present disclosure.

FIG. 3 is a schematic view of a gantry system, according to an example embodiment of the present disclosure.

FIGS. 4A and 4B are perspective views of a point-of-sale (POS) automation system, according to an example embodiment of the present disclosure.

FIG. 4C is a perspective side view of a point-of-sale (POS) automation, according to an example embodiment of the present disclosure.

FIG. 5 is a perspective side view of a gripper, according to an example embodiment of the present disclosure.

FIG. 6A-6C are perspective views of a card stacking system, according to an example embodiment of the present disclosure.

FIGS. 7A-7E are perspective views of a gripper with various movements for an insert-pay mechanism, according to an example embodiment of the present disclosure.

FIGS. 8A-8D are perspective views of a gripper configured to move along a track, according to an example embodiment of the present disclosure.

FIGS. 9A-9E are perspective views of a gripper with various movements for an insert-pay mechanism, according to an example embodiment of the present disclosure.

FIGS. 10A-10C are perspective views of a gantry system, according to an example embodiment of the present disclosure.

FIGS. 11A-11C are perspective views of a gantry system with various movements for a screen/pin-pad mechanism, according to an example embodiment of the present disclosure.

FIGS. 12A and 12B are perspective views of a gantry system including a stylus pin, according to an example embodiment of the present disclosure

FIG. 13 illustrates a schematic block diagram of a system for testing a POS system, according to an example embodiment of the present disclosure.

FIG. 14 is a flowchart illustrating a method of testing a point-of-sale (POS) automation system, according to an example embodiment of the present disclosure.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of layers, regions and/or structural elements may be reduced or exaggerated for clarity. The use of similar or identical reference numbers in the various drawings is intended to indicate the presence of a similar or identical element or feature.

### DETAILED DESCRIPTION

A point-of-sale (POS) automation system, according to the present disclosure, is capable of testing individual systems, such as, a card insert-pay mechanism, a card slide mechanism, a pin-pad mechanism, and/or a touch screen mechanism (for a contactless card) in a modular manner. Using a production line approach with modular individual parts constituting an entire system, the present POS automation system can continually test the functionalities of other parts of the system without interrupting or causing complications with the other parts of the system. By contrast, in the prior solution, if one of the systems fails, the entire system fails causing delays. Accordingly, the present system is to develop a modular and versatile solution that allows an end user to implement a test plan as needed. This results in reduction of costs and time associated with testing POS devices and associated systems by automating testing the POS devices and associated systems.

In some implementations, the proposed system of the present disclosure can test the POS system remotely using, for example, application programming interface (API) calls over secure network, as well as the ability to create various test plans based on the individual parts of the system. Some features of this approach include easy error debugging, easy replacement of parts within each system, and the ability to add more features in the future.

In some implementations, the proposed system of the present disclosure can combine testing of multiple features of the POS system, for example, inserting of EMV chip cards, swiping cards with EMV chip and magnetic strip, and testing pin-pad and touch screen, with an opportunity to choose from a list of available electronic card types (i.e., credit cards, debit cards, stored value cards, gift cards, etc.).

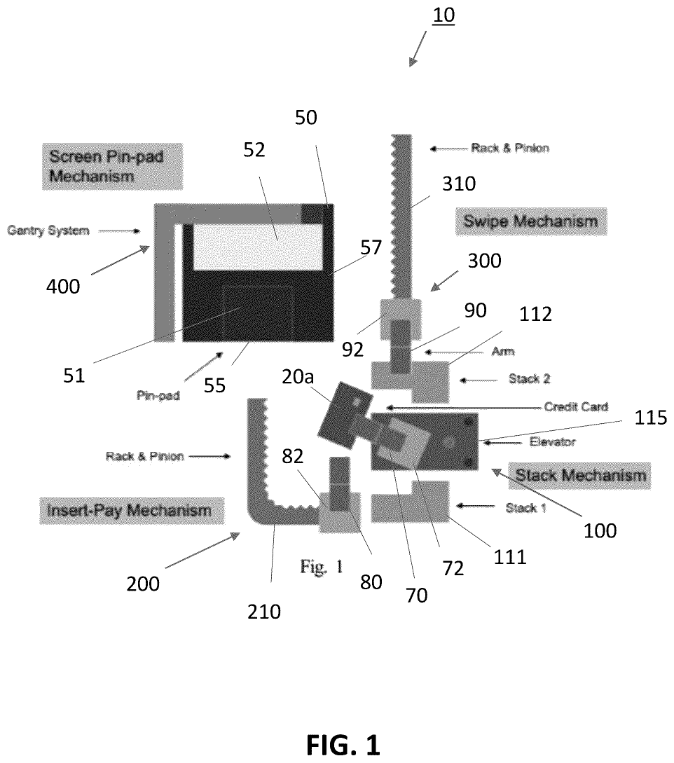

FIG. 1 is a schematic view of a point-of-sale (POS) testing automation system 10, according to an example embodiment. The system 10 includes a card stack mechanism 100 for holding a plurality of cards 20, a card insert-pay mechanism 200 configured to insert one of the plurality of cards 20 into a POS terminal 50 to be tested, a card swipe mechanism 300 configured to swipe one of the plurality of cards 20 into the POS terminal 50 to be tested, and a screen pin-pad mechanism 400 configured to select an operation on a keypad 51 or displayed on a display 52 of the POS terminal 50 associated with one of the card insert-pay mechanism 200 or the card swipe mechanism 300.

Each of the plurality of cards 20 includes a first transaction type and a second transaction type that are implemented in the POS terminal 50. In one implementation, the first transaction type is an interface mode for a microprocessor chip (e.g., Europay, Mastercard and Visa (EMV) chip cards) and the second transaction type is an interface mode for a magnetic strip (e.g., magstrip cards). When the interface mode is the microprocessor chip, the card 20 can be inserted or “dipped” into a card reader 55 of the POS terminal 50. When the interface mode is the magnetic strip, the card 20 can be swiped (or slid) into a card reader 57 of the POS terminal 50. In some implementations, the card 20 can include a third transaction type that is an interface mode for a contactless scan including NFC-enabled digital wallets such as Apple Pay and Google Pay. In this implementation, the card 20 is tapped or hovered over an associated card reader of the POS terminal 50. Examples of the cards 20 may include, but not limited to, credit cards, debit cards, gift cards, loyalty cards, prepaid cards forex cards, or similar electronic cards.

The POS terminal 50 is a hardware device that enables the merchants to process payments to complete a customer purchase. In some implementations, the POS terminal 50 can be a credit card terminal, a debit card terminal, or an Electronic Funds Transfer at Point of Sale (EFTPOS) terminal. Other exemplary embodiments of the POS terminal can be implemented, such as, but not limited to, a smartphone with plugged-in card readers. The POS terminal 50 may be fixed (wired) payment terminal or a portable (wireless) payment terminal communicatively connected to a controller, which will be described in detail later.

The system 10 includes a plurality of arms (i.e., a first arm 70, a second arm 80, and a third arm 90) that is configured to engage (i.e., hold, grab) an associated card 20a and move the associated card 20a to interface with the POS terminal 50. In this context, the term “associated card” 20a is a card selected from the plurality of cards 20 that is to be tested. The first arm 70 is configured to retrieve the associated card 20a from the card stacking mechanism 100. The second arm 80 is configured to transport the associated card 20a to the POS terminal 50 via the card insert-pay mechanism 200. The third arm 90 is configured to transport the associated card 20a to the POS terminal 50 via the card swipe mechanism 300. Each of the arms 70, 80, 90 is communicatively connected to the controller that controls the movement and operation of the arms 70, 80, 90. In some implementations, the arms 70, 80, 90 are identical to each other having the same parts and design. It should be appreciated that the arms 70, 80, 90 can be of different types and devices as long as the functionalities or features (i.e., graspability and maneuverability) are achieved.

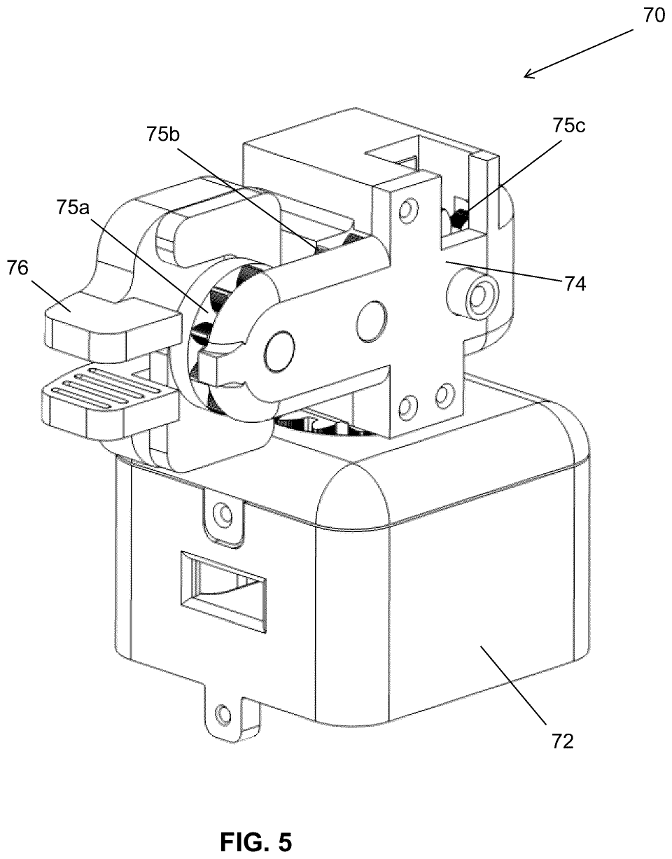

Referring to FIG. 5, arm 70 (and similarly arm 80, 90) includes a first housing member 72 to house a motor(s) (not shown) and a second housing member 74 located above the first housing member 72 to house a plurality of gears 75a-75c for operating a gripper 76. In one implementation, the gripper 76 is a claw inspired gripper. The motor(s) in the first housing member 72 enables the arm 70 to move translationally (i.e., horizontally or vertically) to a desired location and/or enables the gripper 76 to move (i.e., vertically) and grab the associated card 20a thereto. In some implementations, the motor can be a servomotor or a DC motor. In an example embodiment, the servomotor may enable the gripper 76 to grip or release the associated card 20a and the DC motor may enable the arm 70 to move in a horizontal or vertical direction. As shown in FIG. 5, the plurality of gears 75a-75c are arranged in the second housing member 74 to mesh with each other and operate the gripper 76. In some implementations, the plurality of gears 75a-75c are arranged in a vertical configuration to rotate in a clockwise and counter-clockwise directions. For example, when gear 75a rotates in a first direction (i.e., counter-clockwise direction), this enables the gripper 76 to move closer to each other and enables to hold the card 20a. When gear 75a rotates in a second direction (i.e., clockwise direction), this enables the gripper 76 to move farther from each other and enables to release the card 20a. In other implementations, the arms 70, 80, 90 can be designed such that the gripper 76 can rotate and be enabled to rotate the card 20a while holding the card 20a. For example, the gripper 76 can be constructed to rotate 90 degrees to hold the card 20a in a vertical manner or a horizontal manner. To describe differently, if the gripper 76 is holding the card 20a in a horizontal manner, the gripper 76 can be rotated 90 degrees in either direction to hold the card 20a in a vertical manner.

It should be appreciated that arm 80 and/or 90 is similar to arm 70 which is configured to house similar parts and operate in similar manner.

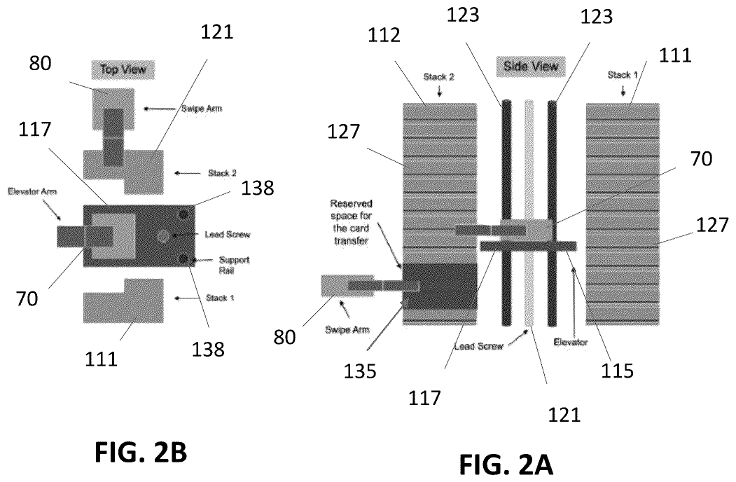

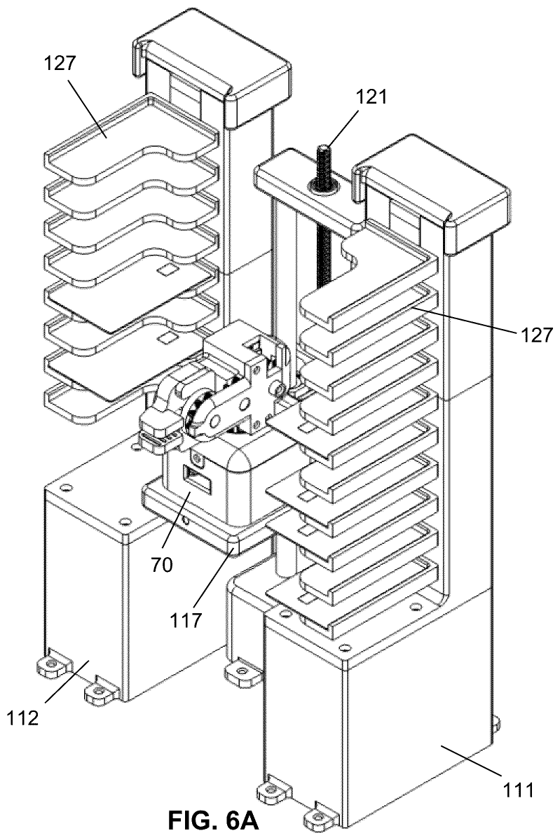

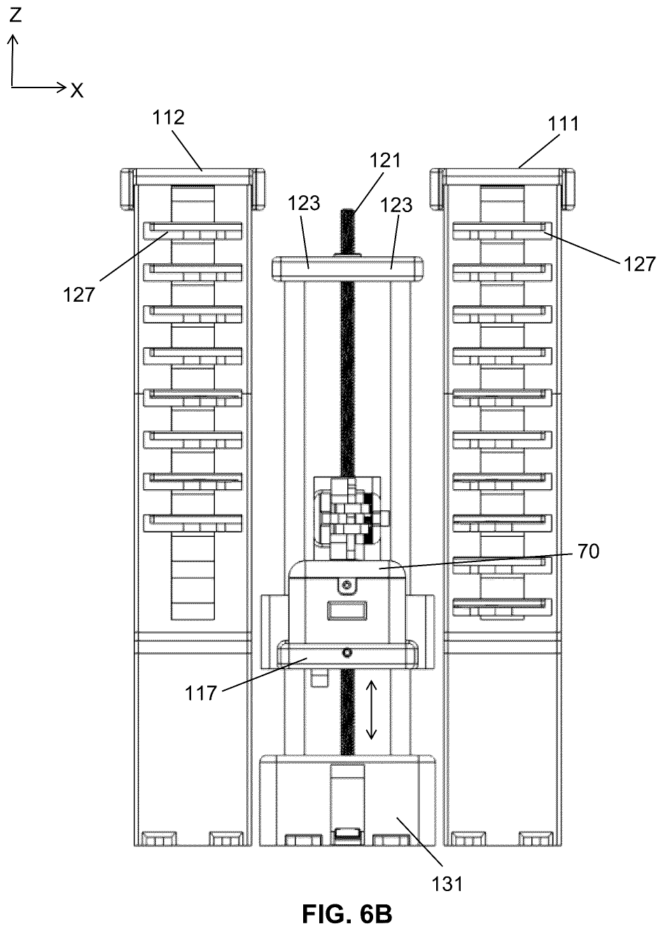

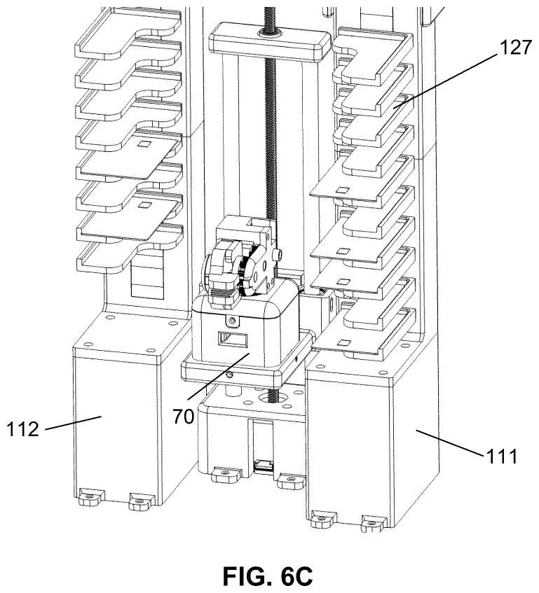

Referring to FIGS. 2A and 2B, the card stack mechanism 100 includes a first card stack 111 and a second card stack 112 for storing a plurality of cards 20 and an elevator 115 to move the first arm 70 in a vertical direction (i.e., up-and-down). In some implementations, the elevator 115 is arranged between the first card stack 111 and the second card stack 112. The elevator 115 supports the first arm 70 on a platform 117 and enables the first arm 70 to engage one of the plurality of cards 20 stored in either the first or second card stacks 111, 112. In other words, the elevator 115 moves the platform 117 up or down to enable the first arm 70 to select one of the plurality of cards 20 stored in either of the first or second card stacks 111, 112. For example, if the associated card 20a located near a top portion of the first card stack 111 is selected to be tested, the elevator 115 moves to the location of the associated card 20a and enables the first arm 70 to turn towards the first card stack 111 and grab the associated card 20a located near the top portion of the first card stack 111. Once the associated card 20a is grabbed, the elevator 115 moves down to its starting position to transfer the associated card 20a to either the second arm 80 or the third arm 90 which is to be delivered to the respective card insert-pay mechanism 200 or the card swipe mechanism 300. In some implementations, each of the first and second card stacks 111, 112 includes slots 127 for storing the plurality of cards 20 in a vertical stack configuration. In one implementation, each of the first card stack 111 and the second card stack 112 can have 11 slots 127 to store up to 11 cards, as shown in FIGS. 6A and 6B. In other implementations, the first card stack 111 and the second card stack 112 can have different number of slots 127 for storing the cards 20, as shown in FIG. 2A. By way of example, the first card stack 111 can have 11 slots 127 for storing 11 cards 20 and the second card stack 112 can have 8 slots 127 for storing only 8 cards 20. In this implementation, the second card stack 112 has a receiving area 135 for transferring the associated card 20a from the first arm 70 to the second arm 80. In other words, after the associated card 20a has been retrieved by the first arm 70, the receiving area 135 enables a space for transferring the associated card 20a to the second arm 80. That is, the first arm 70 positions the associated card 20a such that the second arm 80 may retrieve the associated card 20a that is currently gripped by the first arm 70. To this end, the first arm 70 and the second arm 80 are aligned such that the arms 70, 80 have the same Y-coordinates and same orientations.

The elevator 115 is supported and controlled by a drive shaft member 121 which is operated by a motor (not shown) housed in a housing 131 (shown in FIG. 6B) to permit the elevator 115 to move up and down. In one implementation, the drive shaft member 121 is a lead screw. For example, when the drive shaft member 121 rotates in a first direction, the elevator 115 is enabled to move in an upward direction. When the drive shaft member 121 rotates in a second direction (opposite the first direction), the elevator 115 is enabled to move in a downward direction. A pair of support rods 123 are provided to support the platform 117 and enabled for stability while moving. In some implementations, the pair of support rods 123 is located at each side of the drive shaft member 121. The platform 117 includes corresponding holes 138 to enable the support rods 123 to slide therein, as shown in FIG. 2B.

It should be appreciated that the card stack mechanism 100 is not limited by the shape and form as depicted in FIGS. 1, 2A and 2B and other shapes and forms of the card stack mechanism 100 are within the scope of the embodiment.

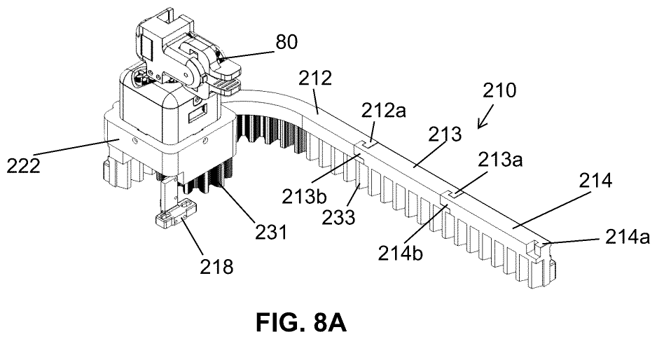

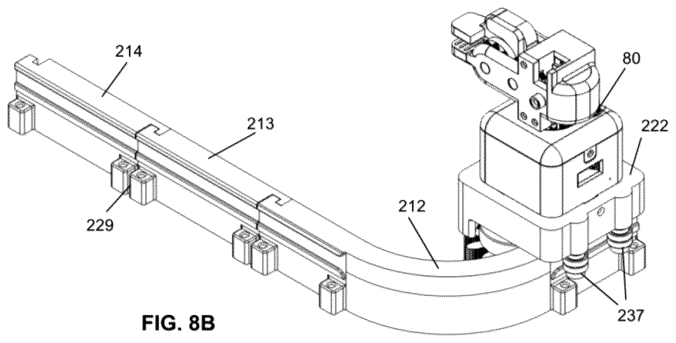

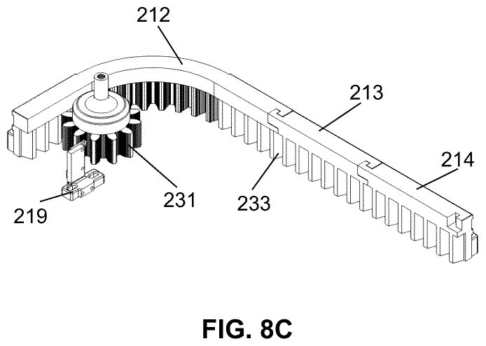

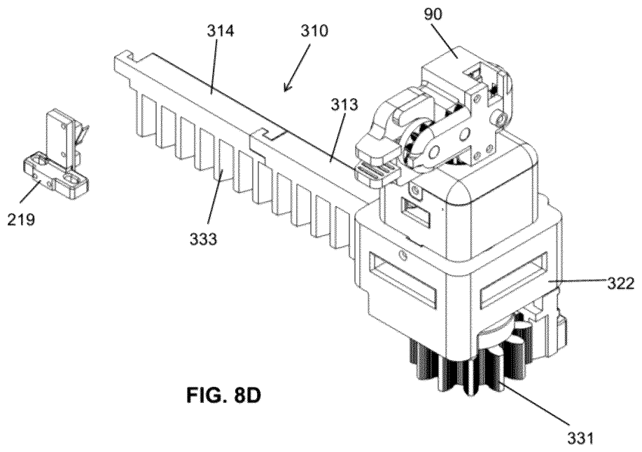

Referring back to FIG. 1, the card insert-pay mechanism 200 encompasses the second arm 80 traveling on an insertion-pay track portion 210 so as to enable the associated card 20a to be inserted in the microprocessor chip reader 55 of the POS terminal 50. In this implementation, the associated card 20a has an embedded microprocessor chip for processing data. That is, once the second arm 80 receives the associated card 20a from the first arm 70, the second arm 80 moves, via the insertion-pay track portion 210, towards the POS terminal 50 to be tested. The insertion-pay track portion 210 includes a plurality of tracks 212, 213, 214, as shown in FIGS. 8A and 8B. In one implementation, the insertion-pay track portion 210 constitute substantially a L-like formation of the insertion-pay track portion 210, whereby track 212 is substantially curved and tracks 213 and 214 are substantially linear or straight. Each of the plurality of tracks 212, 213, 214 has respective ends that are cooperatively engageable with each other. For example, a first end 212a of track 212 is cooperatively engaged to a second end 213b of track 213 and a first end 213a of track 213 is cooperatively engaged to a second end 214b of track 214. In an example embodiment, ends 213b and 214b has a substantially L-like shape that cooperatively engages (or mates) to respective ends 212a and 213a having corresponding opposite L-like shaped ends. It should be appreciated that other end designs can be employed to cooperatively engage the ends of the tracks 212, 213, 214 together. Further, while the example embodiments described herein included 3 tracks, it should be appreciated that more or less tracks can be employed depending on the layout of the testing system 10. In some implementations, each track 212, 213, 214 can include a raised portion 229 on an exterior portion thereof to secure the tracks 212, 213, 214 against a surface (e.g., a table, a worksurface, a counter, a platform, etc.), as shown in FIG. 8B.

In some implementations, as shown in FIGS. 8A and 8C, an end guard rail 218 is provided to prevent further movement of the arm 80. For instance, end guard rail 218 associated with arm 80 is near both ends of the insertion-pay track portion 210 to prevent the arm 80 from extending beyond the insertion-pay track portion 210. It should be appreciated that other guard rails (not shown) can be employed along the insertion-pay track portion 210 to maintain the arm 80 in its proper track. These guard rails can be of multiple components or of a unitary structure that extends along the swipe-pay track portion 310

The second arm 80 is disposed on a housing member 222 that is movable along the plurality of tracks 212, 213, 214. The housing member 222 includes a motor (not shown) to operate a drive member 231 to move the housing member 222. In one implementation, the drive member 231 is a drive gear. In order to move the second arm 80 along the plurality of tracks 212, 213, 214, the motor rotates the drive gear 231 that can be meshed with a linear gear 233 (i.e., teeth) formed on a side portion of each of the plurality of the tracks 212, 213, 214. In other words, the drive gear 231 and linear gear 233 constitute a rack and pinion steering system for translational movement. Because the second arm 80 is disposed on the housing member 222 including the drive gear 231 that engages the linear gear 233, the second arm 80 moves along the plurality of tracks 212, 213, 214 in a corresponding manner. On an exterior surface thereof (i.e., opposite side of linear gear 233), the housing member 222 includes a pair of rollers 237 to help maintain the housing member 222 against the plurality of tracks 212, 213, 214 during translational movement, as shown in FIG. 8B. In other words, the rollers 237 keep the housing member 222 to remain on the tracks 212, 213, 214 and prevent misalignments. In some implementations, the rollers 237 can include a material, such as rubber, to improve grippability applied against the tracks 212, 213, 214 and/or a lubricant, such as oil to reduce friction.

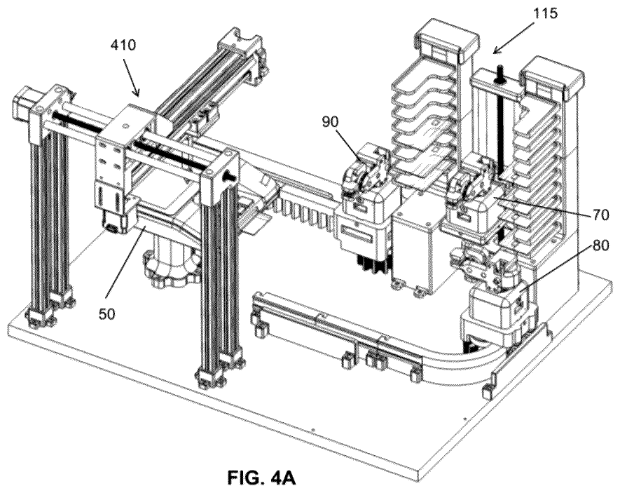

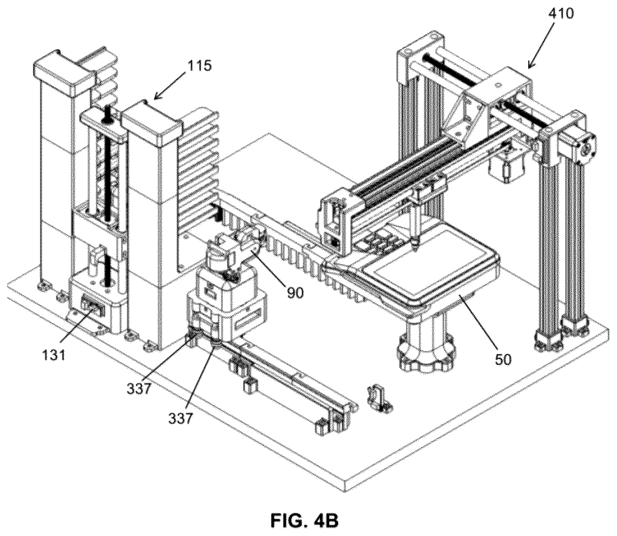

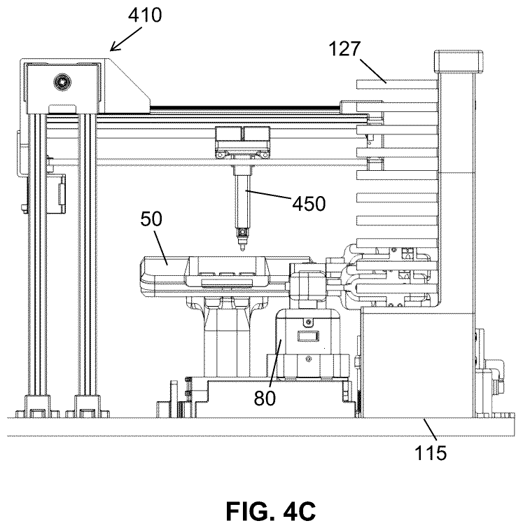

In a similar manner, referring to FIG. 8D, the third arm 90 is disposed on a housing member 322 that is movable along a swipe-pay track portion 310 so as to enable the associated card 20a to be swiped in the chip reader 57 of the POS terminal 50. In this implementation, the associated card 20a has a magnetic strip on a back surface thereof for processing data. As shown in FIG. 8D, the swipe-pay track portion 310 has a plurality of tracks 312, 313, 314 for translation movement of the third arm 90. In one implementation, tracks 312, 313, 314 are substantially linear or straight. As similarly discussed above, tracks 312, 313, 314 can be cooperatively engaged to each other, for example, ends having a substantially L-like shape that cooperatively engage (or mate) to respective ends of corresponding opposite L-like shaped ends. The third arm can move via a drive gear 331 and a linear gear 333 that constitutes as a rack and pinion system for translational movement. On an exterior surface thereof (i.e., opposite side of the linear gear 333), the housing member 322 includes a pair of rollers 337 to help maintain the housing member 322 against the tracks 312, 313, 314 during movement, as shown in FIG. 4B. In some implementations, each track 312, 313, 314 can include a raised portion 229 to secure the tracks 312, 313, 314 against a surface (e.g., a table, a worksurface, a counter, a platform, etc.). While the example embodiments described herein included only 3 tracks, it should be appreciated that more or less tracks can be employed depending on the layout of the system 10.

In some implementations, as shown in FIG. 8D, an end guard rail 219 is provided to prevent further movement of the arm 90. For instance, end guard rail 219 associated with arm 90 is near both ends of the swipe-pay track portion 310 to prevent the arm 90 from extending beyond the swipe-pay track portion 310. It should be appreciated that other guard rails (not shown) can be employed along the swipe-pay track portion 310 to maintain the arm 90 in its proper track. These guard rails can be of multiple components or of an unitary structure that extends along the swipe-pay track portion 310.

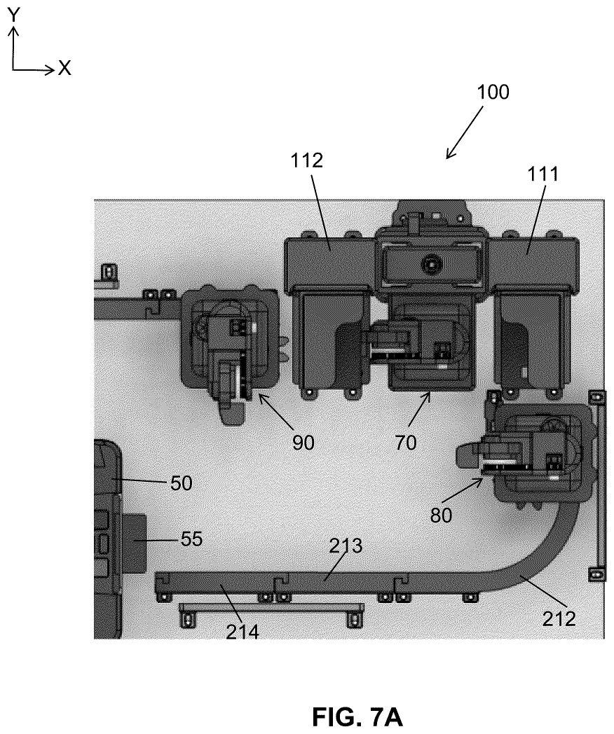

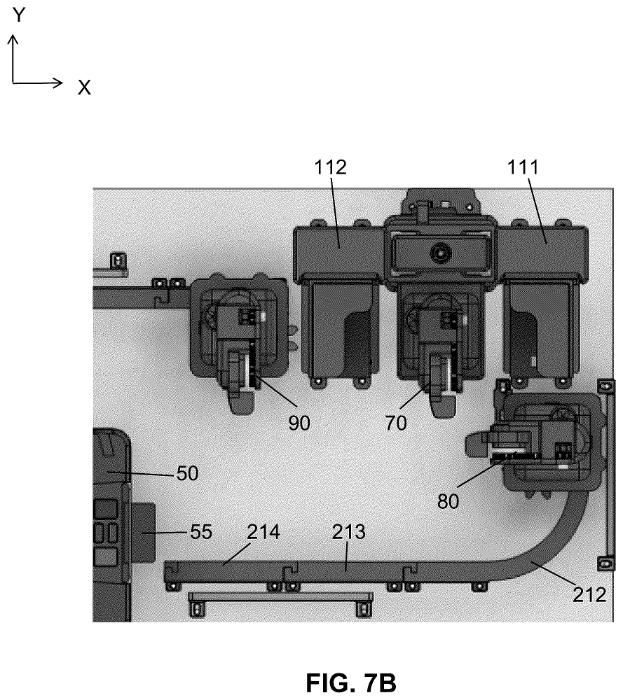

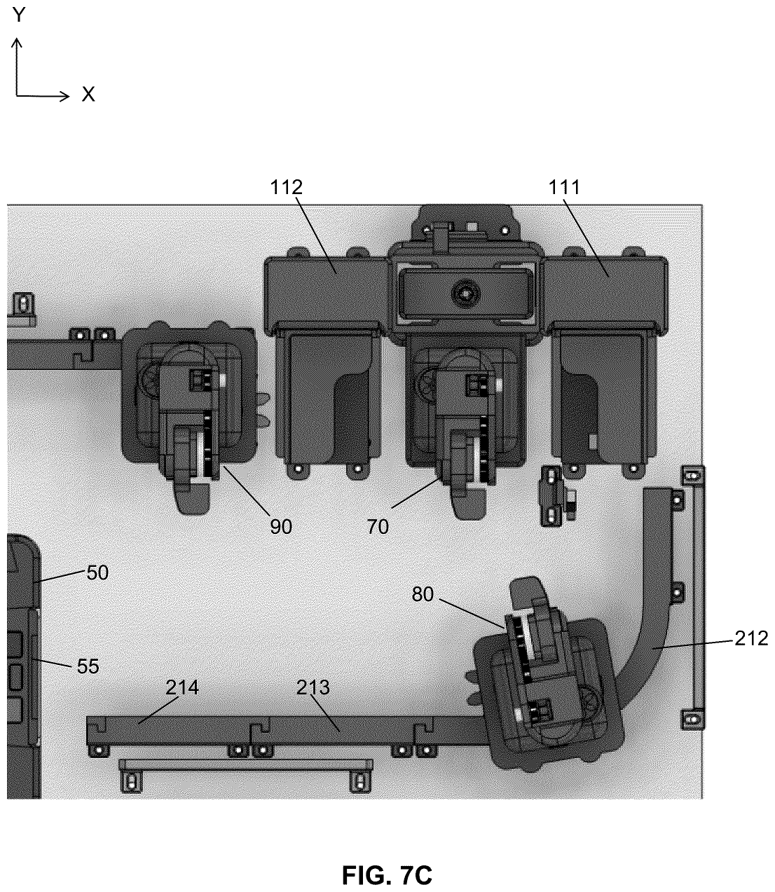

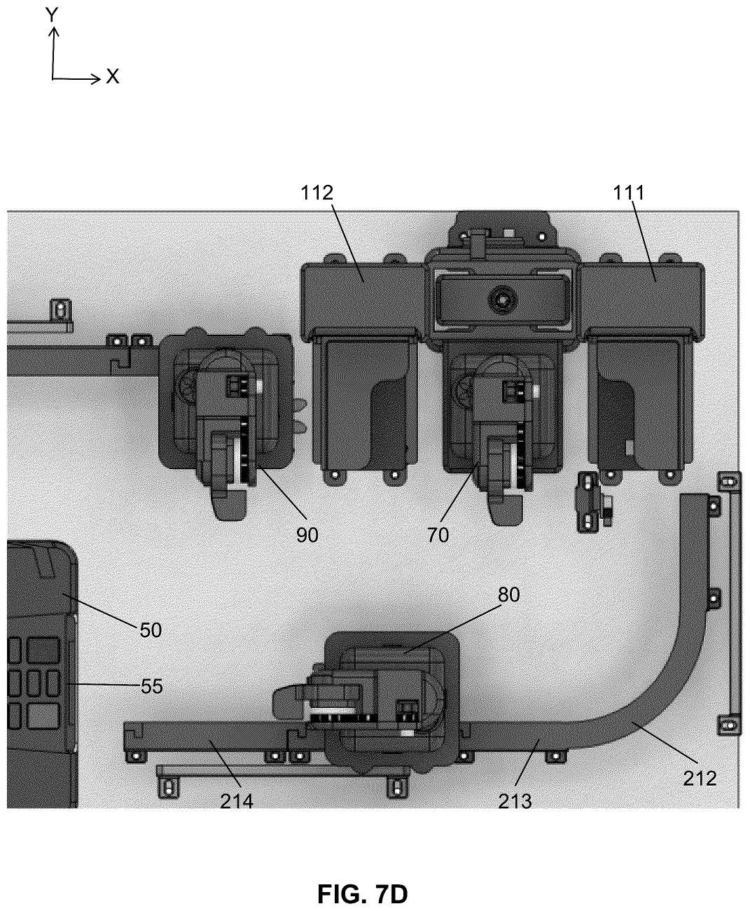

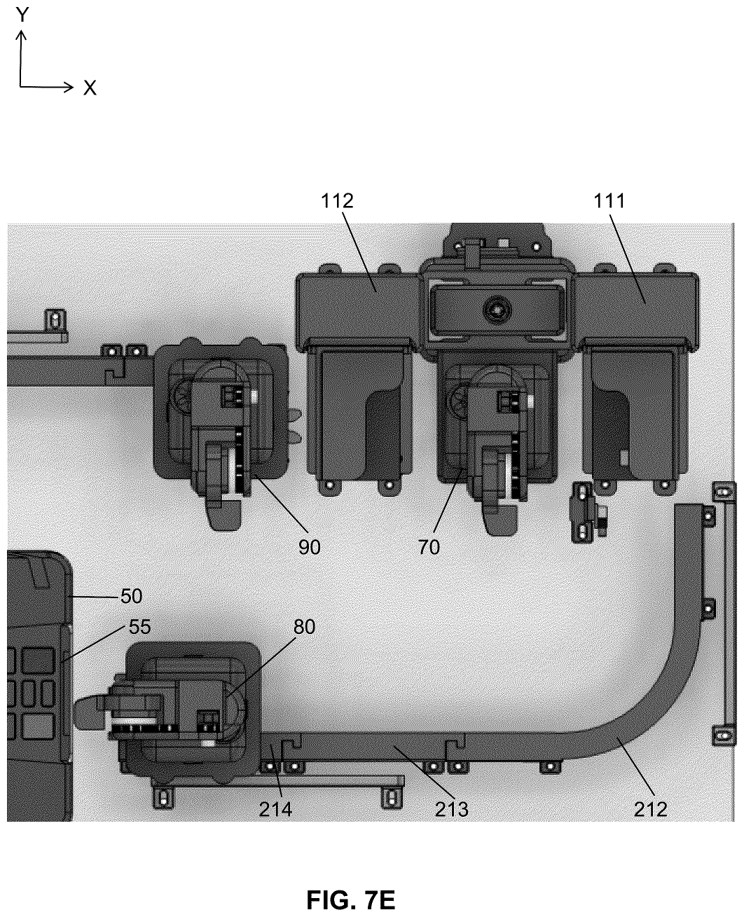

FIGS. 7A-7E illustrate movements of the second arm 80 in the card insert-pay mechanism 200 according to an example embodiment. As shown in FIG. 7A, the first arm 70 retrieves an associate card 20a (not shown) having a microprocessor chip from the second card stack 112. To this end, the first arm 70 includes a motor to grip the associate card 20a via the gripper 76 and retrieve the card 20a from the second card stack 112. Since the system 10 is operating in the card insert-pay mechanism 200, the first arm 70 grips the associate card 20a at one long side portion of the associate card 20, so that no additional movements are required during transferring of the associate card 20a (i.e., rotation of the associate card). As shown in FIG. 7B, once the associate card 20a is grabbed by the first arm 70, the first arm 70 is rotated (i.e., 90°) towards the second arm 80 to engage with the second arm 80. At this stage, the first arm 70 is positioned so that the second arm 80 can retrieve the associate card 20a that is currently gripped by the first arm 70. To this end, the first arm 70 and the second arm 80 are aligned such that the first arm 70 and the second arm 80 have the same y-coordinates (i.e., same plane level). That is, the first arm 70 may modify its vertical position in order to align with the second arm 80 so that the second arm 70 can easily retrieve the associate card 20a. At this stage, the second arm 80 grips the associate card 20a at one short end portion of the associate card 20a (i.e., distal from the microprocessor chip). As shown in FIG. 7C, once the second arm 80 grips the associate card 20a, the second arm 80 moves along the insertion-pay track portion 210, in particular, track 212, towards the POS terminal 50. By way of example, the second arm 80 will move towards the end portion (i.e., 212a) of track 212 and stop at or near the end portion 212a of the track 212. Next, the second arm 80 rotates (i.e., 90°) towards the POS terminal 50 causing the associate card 20a to face the card reader 55 of the POS terminal 50. To this end, the motor within the housing member 222 moved the second arm 80 along track 212 towards the POS terminal 50. At this stage, the associate card 20a is at a position where the associate card 20a can be inserted in the card reader 55 of the POS terminal 50. As shown in FIGS. 7D and 7E, the second arm 80 moves along tracks 213 and 214 consecutively so as to insert the associate card 20a into the card reader 55 of the POS terminal 50 for testing.

In some implementations, the system 10 can be implemented to test for failure during the card insert-pay mechanism 200 and revert to the card swipe-pay mechanism 300 for further testing. For example, the system 10 can implement a testing suite to conduct a “fall-back” scenario where the associated card 20a is inserted and failed to read at least three times due to the chip error (or other failures). Once failure occurred, the system 10 will operate in the card swipe-pay mechanism 300 for further testing. This enables a system to test individual mechanisms in a modular approach, rather than disrupting the functionalities of the other systems. In addition, this may determine which individual features of the POS system has the error rather than completely shutting down the entire POS system causing delays.

In some implementations, the system 10 can also be implemented to test for failure during the card swipe-pay mechanism 300 and revert to the card insert-pay mechanism 200 for further testing. For example, the system 10 can implement a testing suite to conduct a “fall-back” scenario where the associated card 20a is swiped and failed to read at least three times due to the magnetic strip (or other failures). Once failure occurred, the system 10 will operate in the card insert-pay mechanism 200 for further testing.

In some implementations, the system 10 can further be implemented to test for failure during the card screen pin-pad mechanism 400 for further testing. For example, the system 10 can implement a testing suite to conduct a “fall-back” scenario where the associated card 20a fails during the card insert-pay mechanism 200 and the card swipe-pay mechanism due to failure of card reading. Once failure occurred, the system 10 will operate in the card screen pin-pad mechanism 400 for further testing.

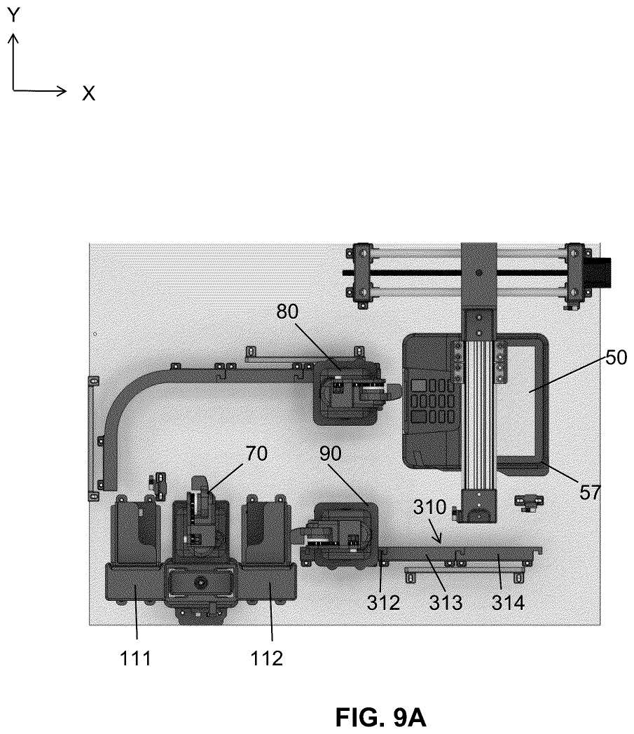

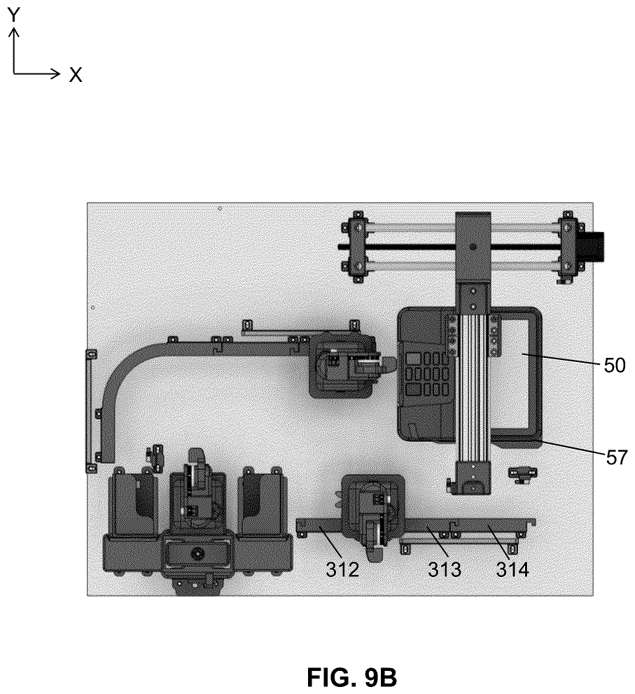

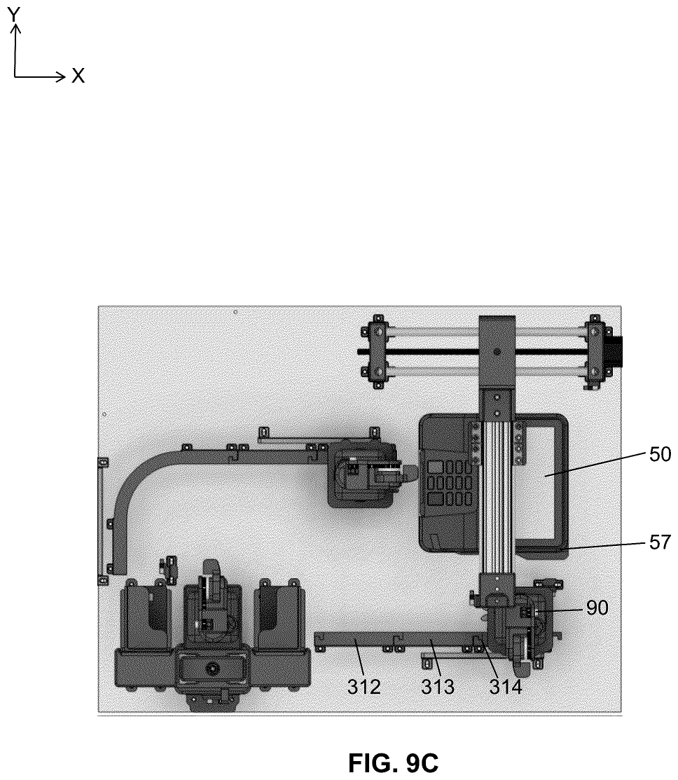

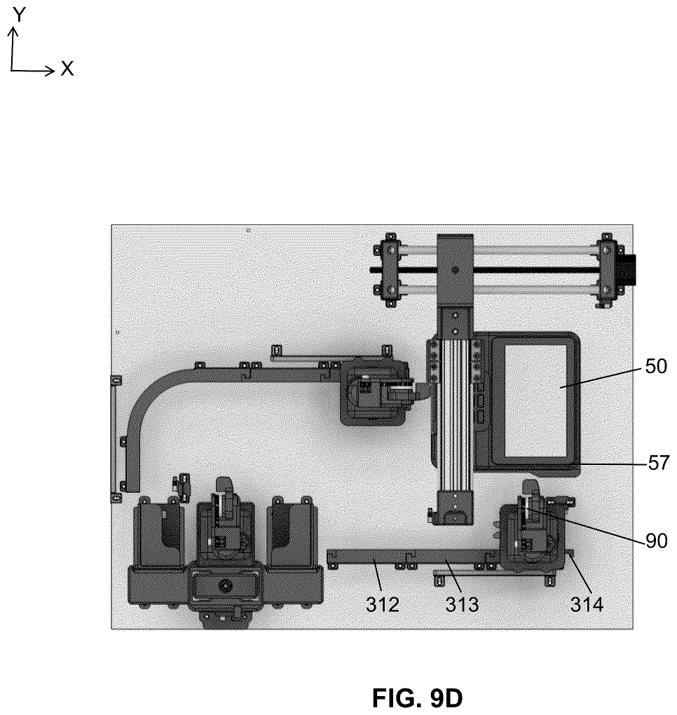

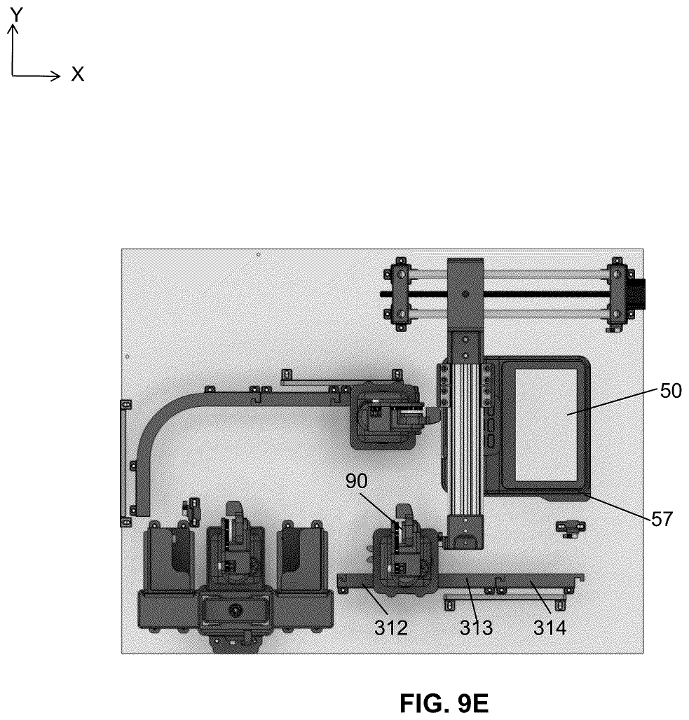

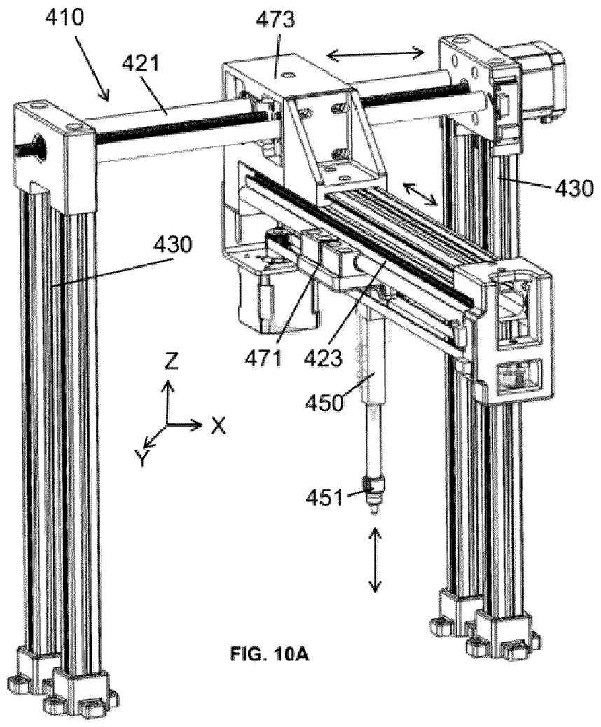

FIGS. 9A-9E illustrate movements of the third arm 90 in the card swipe-pay mechanism 300 according to an example embodiment. As shown in FIG. 9A, the third arm 90 retrieves an associate card 20a (not shown) having a magnetic strip from the second card stack 112. In one implementation, the third arm 90 grips the associate card 20a at one long side portion of the associate card 20, i.e., opposite from the magnetic strip. As shown in FIG. 9B, once the associate card 20a is grabbed by the third arm 90, the third arm 90 is rotated (i.e., 90°) away from the POS terminal 50. That is, with reference to FIG. 9B, the third arm 90 is rotated to the left with respect to the swipe-pay track portion 310 that includes tracks 312, 313, 314. As shown in FIG. 9C, the third arm 90 continues moving along the swipe-pay track portion 310, more specifically, from track 312 to track 314 until it reaches near an end portion of track 314. As shown in FIG. 9D, the third arm 90 is then rotated 180° so that the associate card 20a, i.e., the magnetic strip, is now facing the POS terminal 50. To this end, the motor within the housing member 322 moved the third arm 90 from track 312 to track 314. At this stage, the associate card 20a is at a position where the associate card 20a can be swiped in the card reader 57 of the POS terminal 50. As shown in FIG. 9E, the third arm 90 moves back towards track 312 so as to swipe the associate card 20a through the card reader 57 of the POS terminal 50 for testing.

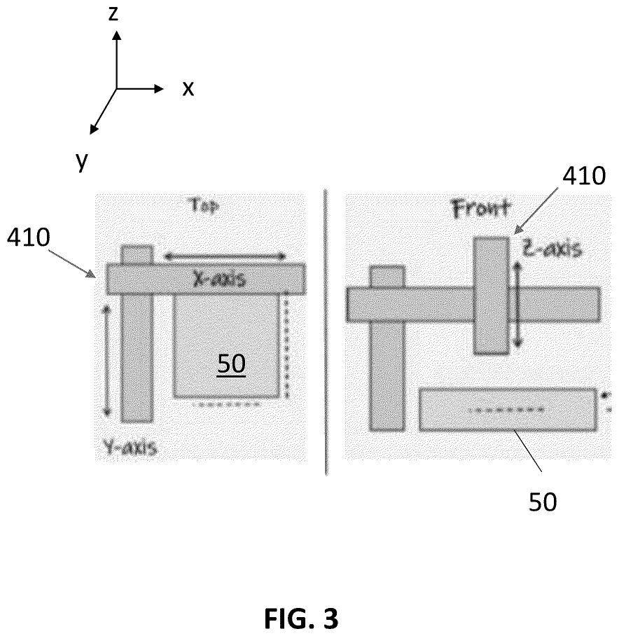

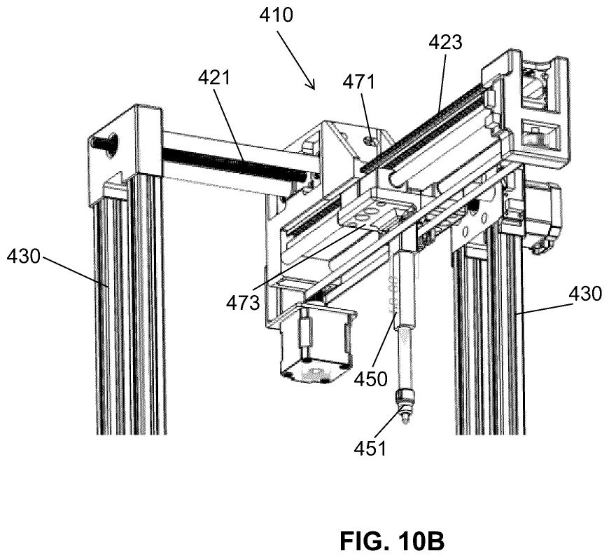

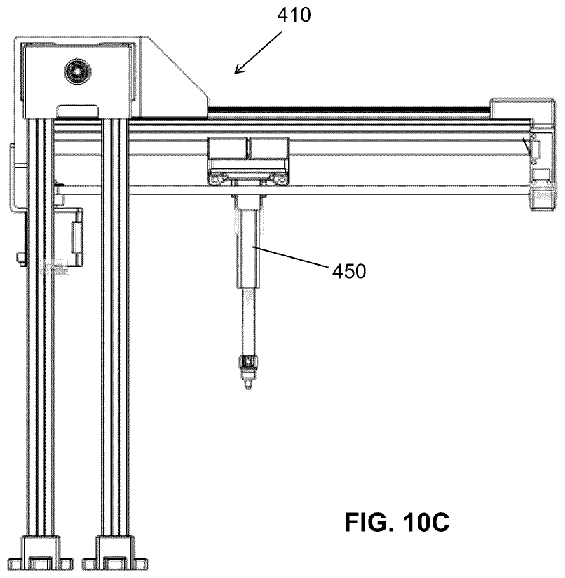

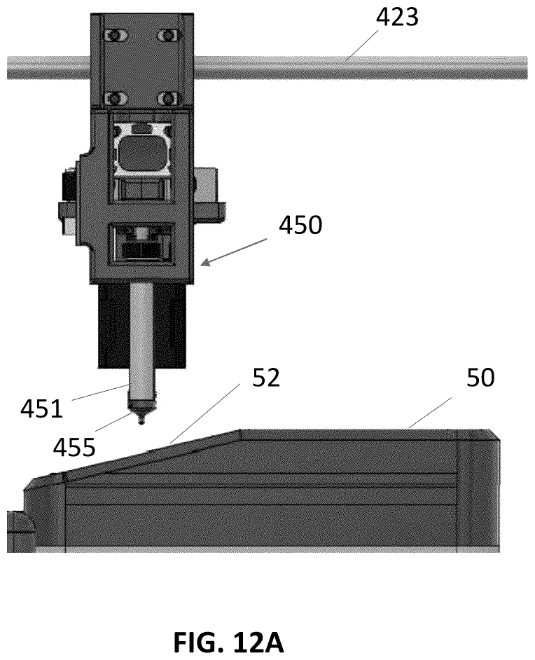

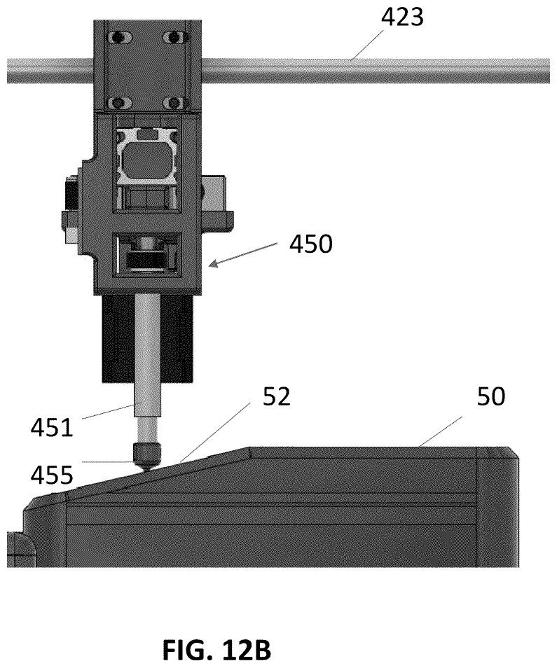

Referring now to FIG. 3, the screen pin-pad mechanism 400 of system 10 includes a gantry system 410 configured to allow an input device 450 (as shown in FIG. 10A) to move translationally along at least one of three axes (e.g., X, Y, Z) over the POS terminal 50. By way of example, after the card 20 has been interfaced with the POS terminal 50 via the card insert-pay mechanism 200, the controller instructs the input device 450 based on the inserted microprocessor chip to provide an input (i.e., a code, a pin, a zip code, a telephone number, a date of birth, etc.). For example, the controller may instruct the input device 450 to “enter pin” or “provide pin”, which may be a 4-digit PIN used to authorize a transaction associated with the card. To this end, the controller may instruct the input device 450 to interface with and move towards a keypad 51 on the POS terminal 50, as shown in FIGS. 12A and 12B. In some implementations, the input device 450 may include a stylus or pen 451 to press keys/button on the keypad 51. The controller may align the stylus or pen 451 over the keypad 51, so that the stylus 451 is aligned directly over the respective keys on the keypad 51 for entering data. In some implementations, at a distal end of the stylus 451, a tip 455 made from rubber, for example, is attached to provide padding, non-slip resistance, and/or reduce fatigue to the keys/buttons. After the code on the keypad 51 has been input, the input device 450 then presses, for example, an “enter” button or “end” button to submit the code and complete the transaction. When the current status of the POS terminal 50 changes to “transaction complete,” the controller instructs the input device 450 to return back to its original or resting position of the gantry system 410.

Referring to FIG. 10A-10C, the gantry system 410 includes a first rail 421 supported by a pair of supports 430 at each end of the first rail 421 for translational movement in the Y-direction and a second rail 423 for translational movement in the X-direction. By way of example, a first block 471 is connected to the first rail 421 that is moveable (i.e., slideable) on the first rail 421 in the Y-direction, and a second block 473 connected to the second rail 423 that is moveable (i.e., slideable) on the second rail 423 in the X-direction. Each of the first block 471 and the second block 473 moves along their respective rails 421, 423 to position the input device 450 in a desired position to engage the stylus 451 to the keypad 51. In other words, the first rail 421 and the second rail 423 are used to position the input device 450 to a desired coordinate over keypad 51, and enable the stylus 451 to move down (in the Z-direction) to engage with keys in the keypad 51.

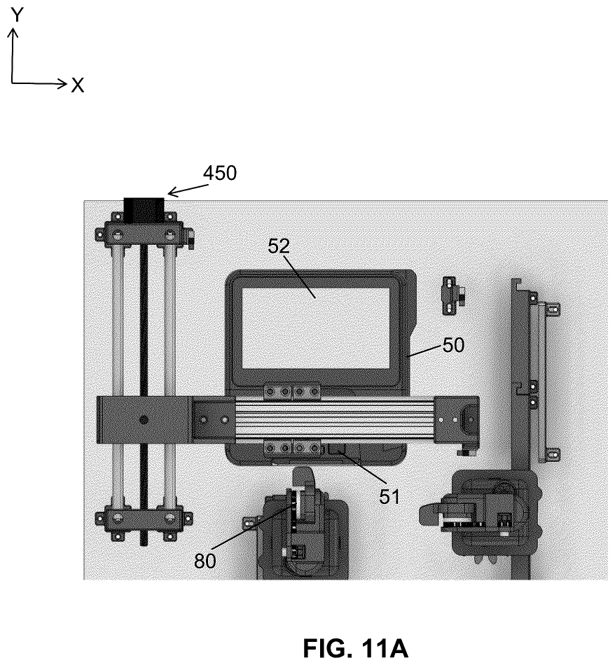

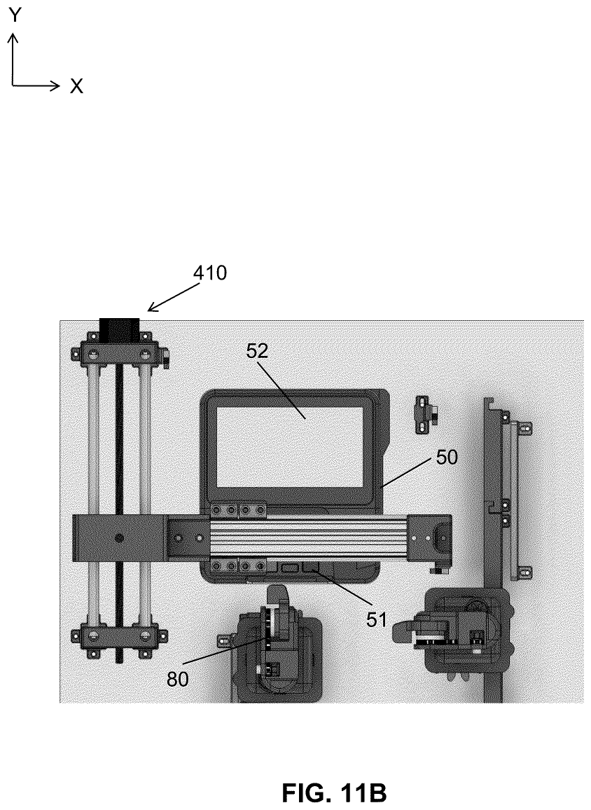

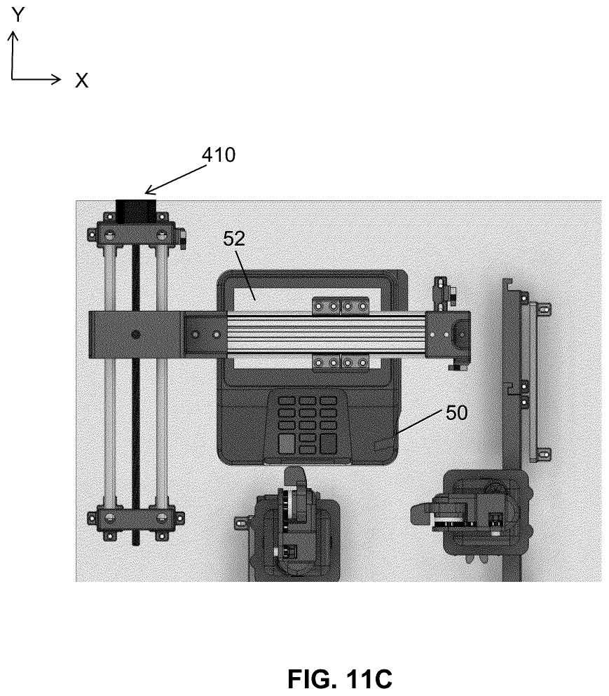

Referring to FIG. 11C, in an alternative embodiment, the input device 450 can further engage with the display 52 of the POS terminal 50 for a screen touch feature. By way of example, the input device 450 hovers over the display 52 until the controller instructs the input device 450 to engage (i.e., touch) the display 52 on the POS terminal 50. In one implementation, the input device 450 may be controlled to input the authorized user's signature. In other implementations, the input device 450 may be controlled to tap on instructions (e.g., “yes” or “no”) that are displayed on the display 52. To this end, each of the first block 471 and the second block 473 moves along their respective rails 421, 423 to position the input device 450 in a desired position so that the stylus 451 engages the display 52.

In some implementations, the gantry system 410 can be equipped with a specific support (not shown) in order to hold an object to perform the test. For example, the support can be used to hold a contactless payment card over the POS terminal 50. In other examples, the support can be used to hold a smartphone or smartwatch to process a digital credit card, such as, for example, Apple Pay or Google Pay.

In some implementations, the POS system 10 may include a robotic arm (not shown) that performs functionalities of the first arm 70, the second arm 80, the third arm 90, the gantry system 410, and/or the input device 450. In this embodiment, each of the first arm 70, the second arm 80, the third arm 90, the gantry system 410, and/or the input device 450 can be replaced by the robotic arm. The robotic arm may alone perform all the functionalities of the first arm 70, the second arm 80, the third arm 90, the gantry system 410, and/or the input device 450, as described above. The controller may be in communication with the robotic arm and may control the robotic arm in order to perform various functionalities of aforementioned devices and systems.

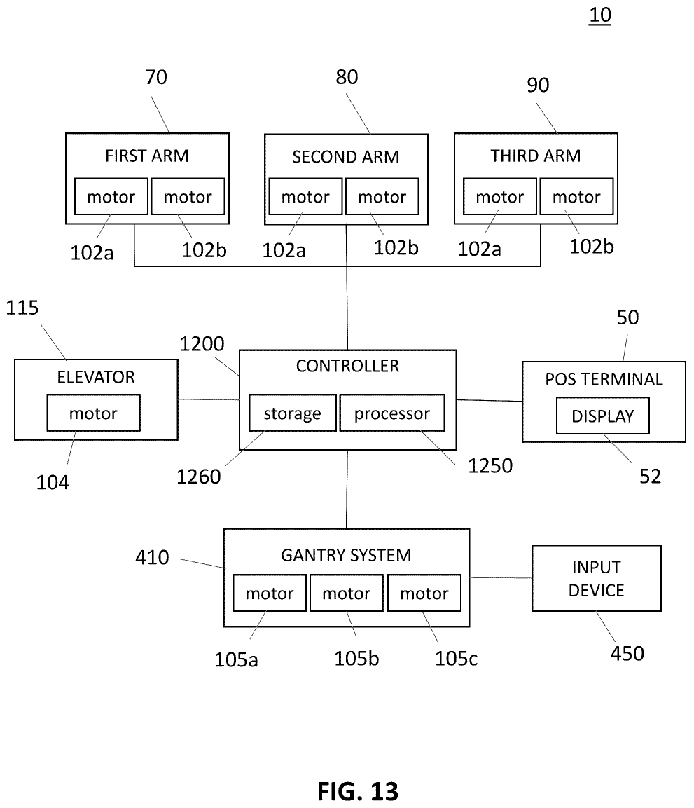

FIG. 13 is a schematic representation of the exemplary POS testing automation system 10, according to an example embodiment. In the schematic representation, a controller 1200 may be communicatively coupled to each of the first arm 70, the second arm 80, the third arm 90, the POS terminal 50, the gantry system 410, the elevator 115, and/or the input device 450. In one implementation, the controller 1200 may be a computing system that includes a processor 1250 and a storage system 1260. The storage system 1260 includes software, including testing suites, and stored data, including data in database structure. In one implementation, the software interface is an application programming interface (API) that implements the testing suites. For example, the API software produces calls, via the Internet, to access the testing plans. In some implementations, the processor 1250 loads and executes software, including the testing suites, which is a software application stored in the storage system 1260. The processor 1250 can also access data stored in the database in order to carry out the methods and control instructions described herein. Although the controller 1200 is depicted in FIG. 12 as one, unitary system encapsulating one processor 1250 and one storage system 1260, it should be appreciated that one or more storage systems 1260 and one or more processors 1250, may comprise the controller 1200, which may be a cloud computing application and system. The processor 1250 includes a processor, which may be a microprocessor, a general-purpose central processing unit, an application-specific processor, a microcontroller, or any type of logic device. The processor 1250 may also include circuitry for retrieving and executing software, including the API calls. It should be appreciated that the processor 1250 may be implemented with a single processing device, but may also be distributed across multiple processing devices or subsystems that cooperate in executing software instructions.

The storage system 1260 may comprise any storage media, or group of storage media, readable by processor 1250, and capable of storing software and data. The storage system 1260 can include volatile and non-volatile, removable and non-removable media implemented in any method or technology for storage of information, such as computer-readable instructions, data structures, program modules, or other data. The storage system 1260 may store a set of processor instruction or algorithm, which when executed by the controller 1200 enables automatic testing of the POS system 10. Examples of the non-volatile memory may include, but are not limited to, a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM) and Static Random-Access memory (SRAM).

The controller 1200 provides control instructions to each of the first arm 70, the second arm 80, and/or the third arm 90, that is executed by motor controllers 102a, 102b which controls a motor driving housing (i.e., 131, 222, 322) that holds the arms 70, 80, 90 for linear translational movements. The control instructions may be individually configured for each arm 70, 80, 90. That is, the control instructions may move the respective arms 70, 80, 90, based on a type of transaction, for example, a card insert-pay mechanism 200 or a card swipe-pay mechanism for testing. For example, the control instructions may instruct the second arm 80 or the third arm 90 to move on a two-axis system (i.e., X-Y coordinate), and/or the first arm 70 to move in a vertical manner (i.e., Z coordinate) to retrieve the appropriate card. In other implementations, the control instructions may further provide instructions to the motor controllers 102a, 102b to control the gripper 76 of each arm 70, 80, 90 in order to hold and release the cards 20 at appropriate times.

The control instructions may also provide instructions to a motor 104 that operates the elevator 115. By way of example, the controller 1200 provides control instructions to the elevator 115 to move the platform 117 that supports the first arm 70 in a vertical direction (i.e., up-and-down) such that the first arm 70 is configured to engage one of the plurality of cards 20 stored in either the first or second card stacks 111, 112.

The control instructions may further provide instructions to motors 105a, 105b, 105c that operate the gantry system 410. By way of example, the controller 1200 provides control instructions to the first block 471, via the motor 105a, that is slideable on the first rail 421 in a linear movement, i.e., the Y-direction, and/or the second block 473, via the motor 105b, that is slideable on the second rail 423 in a linear movement, i.e., the X-direction to position the input device 450 in a desired position to position above the keypad 51 or the display 52 of the POS terminal 50. In addition to controlling the first block 471 and the second block 47 for linear movements, the controller may instruct the input device 450, via a motor 105c, to engage (i.e., touch) the keys on the keypad 51 or the display 52 to activate or achieve a function. In other words, the motor 105c is enabled to operate the input device 450 in a vertical direction (i.e., Z-direction).

It should be appreciated that specifications of the controller are not limited to the embodiments described herein, but may vary depending on the requirements of the POS system

In some implementations, the controller may be uploaded with a test plan for each test mechanism, i.e., the card insert-pay mechanism 200 or the card swipe-pay mechanism 300. In other implementations, the test plan may include details of all the cards that are to be tested with the POS terminal 50, in a sequence.

In some implementations, the controller receives and transmits information/data collected by each of the first arm 70, the second arm 80, the third arm 90, the POS terminal 50, the gantry system 410, the elevator 115, and/or the input device 450 via a receiver/transmitter (not shown). The receiver/transmitter can be configured to be embedded in the first arm 70, the second arm 80, the third arm 90, the POS terminal 50, the gantry system 410, the elevator 115, and/or the input device 450 for communication. The receiver/transmitter may communicate by any wireless communication protocols or means, such as Bluetooth, Wi-Fi, RF transmission, GPS, or the like.

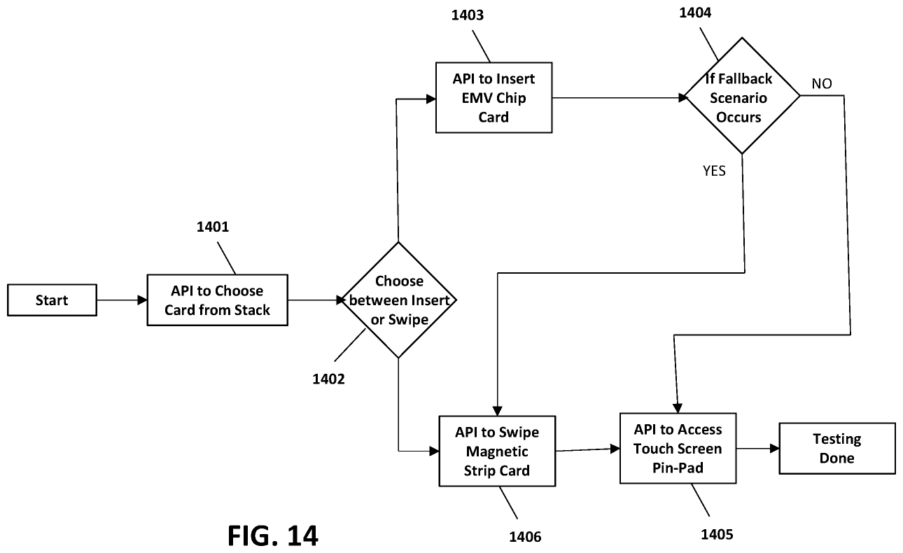

Referring now to FIG. 14, a flowchart of a method for testing the POS system 10 is illustrated, in accordance with an example embodiment. At step 1401, the controller selects a card from a plurality of cards 20 from either the first card stack 111 or the second card stack 112. By way of example, the controller instructs the first arm 70 to move to the selected card to retrieve the card from the first card stack 111 or the second card stack 112. Once the card is grabbed, the first arm 70 moves back to its starting position to transfer the card to the second arm or the third arm 90. At step 1402, the controller determines whether to choose the card insert-pay mechanism 200 or the card swipe-insert mechanism 300. In step S1403, if the card insert-pay mechanism 200 is selected, the second arm 80 is instructed to grip the card from the first arm and move along the insertion-pay track portion 210 so as to enable the card to be inserted in the microprocessor chip reader 55 of the POS terminal 50. Next, in step S1404, the controller can implement a testing suite to conduct a “fall-back” scenario where the card is inserted and failed to read at least three times due to the chip error (or other failures). If no failure occurs, in step S1405, the controller instructs the input device 450 to engage with the keys/buttons of the keypad 51 to enter commands and complete the transaction. In step S1406, if failure occurs, the controller will revert to the card swipe-pay mechanism 300 for further testing. This enables a system to test individual mechanisms in a modular approach, rather than disrupting the functionalities of the other systems. By way of example, the controller instructs the third arm 90 to grab the card from the first arm 70 move along the insertion-swipe track portion 310 so as to enable the card to be swiped having the magnetic strip with the chip reader 57 of the POS terminal 50. Next, when the card swipe is complete, the controller instructs the input device 450 to engage with the keys/buttons of the keypad 51 to enter commands and complete the transaction (S1405). At the conclusion of the test suite or upon certain predetermined conditions resulting from the testing actions, the controller may instruct the arms to act cooperatively to return the card to the card stack, which may be its original position or a different position within the stack.

As illustrated herein, various example embodiments provide a system and method for testing the POS system. The system performs automated testing of the payment terminal within POS systems. As a result, no manual intervention is required in accessing cards and interfacing them with a POS terminal. The system provides a low-cost solution, which can be configured to be implemented to different test cases based on user requirements.

In some implementations, the testing can be performed remotely or on-site.

In some implementations, the point-of-sale (POS) automation system is a modular product that can be integrated into existing manual set-ups and is scalable for large testing environments.

In some implementations, each mechanism is independent from each other, yet the mechanism works in tandem to form an overall system in which each API call can be integrated into a test plan structured to the need of the user.

As described herein, the term “proximal” end relates to an end being closest to the user, and the term “distal” end relates to an end being farthest from the user.

The articles “a” and “an,” as used herein, mean one or more when applied to any feature in embodiments of the present disclosure described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used. The adjective “any” means one, some, or all indiscriminately of whatever quantity.

“At least one,” as used herein, means one or more and thus includes individual components as well as mixtures/combinations.

The transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinarily associated with the specified material(s). The term “consisting essentially of” limits the scope of a claim to the specified elements, steps or material(s) and those that do not materially affect the basic and novel characteristic(s) of the claimed disclosure. All materials and methods described herein that embody the present disclosure can, in alternate embodiments, be more specifically defined by any of the transitional terms “comprising,” “consisting essentially of,” and “consisting of”

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While the disclosure has been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system for testing a point-of-sale (POS) device, comprising:
a stack mechanism configured to hold a plurality of cards;
an insert-pay mechanism configured to insert one of the plurality of cards into the POS device to be tested;
a swipe-pay mechanism configured to swipe one of the plurality of cards into the POS device to be tested; and
a screen pin-pad mechanism configured to select a key on a keypad or an operation displayed on a display of the POS device associated with one of the insert-pay mechanism or the swipe-pay mechanism.

2. The system of claim 1, wherein the stack mechanism includes a first card stack and a second card stack arranged in parallel manner such that a first arm is configured to selectively engage one of the plurality of cards in the first card stack or the second card stack to be tested.

3. The system of claim 2, wherein each of the first card stack and the second card stack includes slots for storing the plurality of cards.

4. The system of claim 3, wherein one of the first card stack or the second card stack has a receiving area for transferring the selected card to the insert-pay mechanism, wherein the receiving area is void of any slots.

5. The system of claim 1, wherein the insert-pay mechanism includes a second arm, wherein the second arm travels on an insertion-pay track portion so as to enable a selected card to be inserted in the POS device.

6. The system of claim 5, wherein the selected card has an embedded microprocessor chip for processing data on the card operated by the insert-pay mechanism.

7. The system of claim 5, wherein the insertion-pay track portion includes a plurality of tracks, each track includes a connecting member at each end portion thereof to cooperatively engage with each track.

8. The system of claim 5, wherein the insertion-pay track portion is substantially L-shaped.

9. The system of claim 1, wherein the swipe-pay mechanism includes a third arm, wherein the third arm travels on a swipe-pay track portion so as to enable a selected card to be swiped in the POS device.

10. The system of claim 9, wherein the selected card has a magnetic strip for processing data on the card operated by the swipe-pay mechanism.

11. The system of claim 9, wherein the swipe-pay track portion includes a plurality of tracks, each track includes a connecting member at each end portion thereof to cooperatively engage with each track.

12. The system of claim 1, wherein the screen pin-pad mechanism includes a gantry system configured to enable an input device to move translationally along at least one of three axes over the POS device.

13. The system of claim 12, wherein the gantry system includes a first rail supported by a pair of supports at each end of the first rail for translational movement in a first direction and a second rail for translational movement in a second direction which is perpendicular to the first direction.

14. A system for testing a point-of-sale (POS) device, comprising:
a plurality of card stacks configured to hold a plurality of cards;
a first arm configured to retrieve a card from the plurality of card stacks;
a second arm, cooperatively interfacing with the first arm, configured to carry the retrieved card to the POS device;
a third arm, cooperatively interfacing with the first arm, configured to carry the retrieved card to the POS device;
an input device configured to interface with a screen or a pin-pad of the POS device to select an operation of transaction; and
a controller communicatively coupled to each of the first arm, the second arm, the third arm, and the input device, wherein the controller is configured to:
insert, via the second arm, the retrieved card into the POS device for testing;
swipe, via the third arm, the retrieved card into the POS device for testing; and
select, via the input device, a press button or a touch screen on the POS device to perform the transaction.

15. The system of claim 14, wherein the controller controls the second arm to insert the retrieved card into the POS device to determine proper operation of the retrieved card.

16. The system of claim 15, wherein the controller controls the third arm to swipe the retrieved card into the POS device when improper operation of the retrieved card is determined during insertion operation of the retrieved card into the POS device.

17. A method of testing a point-of-sale (POS) device, the method comprising:
selecting a card from a plurality of cards, the card including a first transaction type and a second transaction type;
determining a transaction mode for the selected card, wherein the transaction mode is one of an insert-pay mechanism or a card swipe-pay mechanism;
determining a failure of either the insert-pay mechanism or the card swipe-pay mechanism;
switching to the insert-pay mechanism or the card swipe-pay mechanism that is operational when the failure occurs; and
selecting an operation on the POS device to complete a transaction.

18. The method of claim 17, wherein determining a failure of the card insert-pay mechanism includes inserting the selected card into the POS device at least three times.

19. The method of claim 17, wherein determining a failure of the card swipe-pay mechanism includes swiping the selected card into the POS device at least three times.

20. The method of claim 17, wherein selecting an operation on the POS device to complete a transaction includes a gantry system to enable an input device to move translationally along at least one of three axes over the POS device.
